(19) United States
(12) Patent Application Publication
(10) Pub. No.: US 2009/0271466 A1
(43) Pub. Date: Oct. 29, 2009

(54) Data logging with network interfacing feature

(76) Inventors: Edward L. Fields, San Diego, CA (US); Christopher G. Sizemore, San Diego, CA (US); Debra Boezeman, San Diego, CA (US); Selma C. Castanedo, San Diego, CA (US); Tam Nguyen, Oceanside, CA (US); Richard L. Harrison, Bonita, CA (US); Heather D. Kane, San Diego, CA (US); Linda H. Wilcox, San Diego, CA (US)

Correspondence Address: Norris, Braden, Melton & Gregersen, P.L.L.C., Suite 305, 1901 Pennsylvania Avenue, Washington, DC, 20006, US

(21) Appl. No.: 11/594,561

(22) Filed: Nov. 8, 2006

(51) Int. Cl. G06F 15/16

(52) U.S. Cl. 709/201; 709/206

(57) ABSTRACT

A data processing network includes data sourcing entities, data logging entities that log data provided by the data sourcing entities, and a data transport network that supports data transport between the data sourcing entities and the data logging entities. The data logging entities and the data sourcing entities are interfaced to the data transport network in a manner that renders the data transport network transparent to the data logging entities and the data sourcing entities.

### FIELD OF THE INVENTION

The invention relates generally to data processing and, more particularly, to logging data produced in a data processing network.

### BACKGROUND OF THE INVENTION

In data processing networks wherein data processing stations are connected for communication with one another by a data transport network, it is often advantageous to be able to log, and ultimately archive, data that is produced and/or collected at selected ones of the data processing stations. Examples of areas in which logging and archiving network data is advantageous, and in some instances vital, include: onboard ship applications, and military applications in general; financial applications; manufacturing; aviation, and transportation in general; meteorology, geology, and scientific applications in general; and law enforcement, firefighting, and security applications in general. Examples of security applications include surveillance systems for Homeland Defense rescue operations, training, and response.

Some conventional data processing networks accomplish data logging by providing one or more data processing stations that are used as designated logging stations for the specific purpose of logging data produced/collected by one or more other data processing stations in the data processing network. Each designated logging station has a fixed network address. In such an arrangement, removal of a logging station for any reason (e.g., failure of the station, maintenance, etc.) causes an interruption of the data logging service provided by that station. Such an interruption can result in lost data. Furthermore, attempts to use a logging station to perform tasks other than logging can also result in interruption of the data logging service. It is also difficult to add new logging stations.

It is desirable in view of the foregoing to provide for improved data logging services in data processing systems.

### BRIEF DESCRIPTION OF THE DRAWINGS

FIG. 1 diagrammatically illustrates a data processing network according to exemplary embodiments of the invention.

FIG. 2 diagrammatically illustrates the data processing network of FIG. 1 in more detail according to exemplary embodiments of the invention.

FIG. 3 diagrammatically illustrates the data processing network of FIG. 1 in more detail according to exemplary embodiments of the invention.

FIG. 4 diagrammatically illustrates the data processing network of FIG. 1 in more detail according to exemplary embodiments of the invention.

FIGS. 5-7 illustrate exemplary operations that can be performed at a sourcing end according to exemplary embodiments of the invention.

FIGS. 8-10 illustrate exemplary operations that can be performed at a logging end according to exemplary embodiments of the invention.

### DETAILED DESCRIPTION

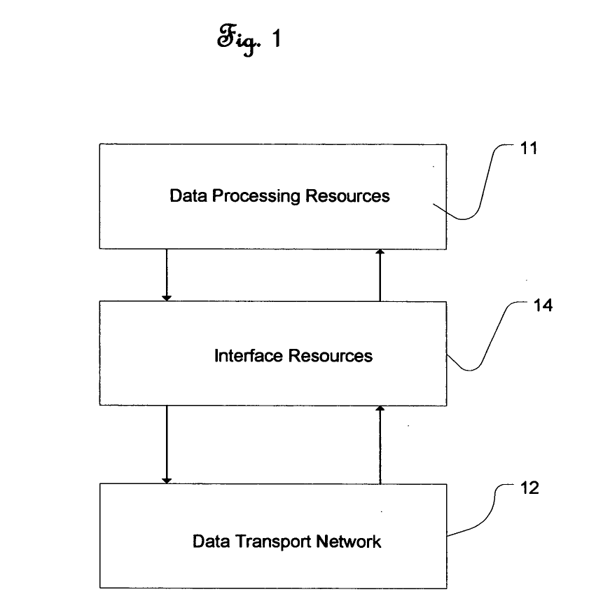

According to exemplary embodiments of the invention, entities that log data in a data processing network, and entities that produce and/or collect the data that is logged, are interfaced to the data transport network in a manner that renders the data transport network transparent to the logging entities and the producing/collecting entities. FIG. 1 diagrammatically illustrates a data processing network according to exemplary embodiments of the invention. The data processing network of FIG. 1 includes data processing resources 11, and a data transport network 12 that supports data communication between the data processing resources. Interface resources 14 are provided between the data processing resources 11 and the data transport network 12. The data processing resources 11 include logging entities that log data, and sourcing entities that produce and/or collect data that is to be logged. The interface resources 14 provide the data processing resources with transparent access to the data transport network 12. For example, the interface resources 14 can receive data from a sourcing entity within the data processing resources 11, and access the data transport network 12 transparently with respect to the sourcing entity. In this transparent access, the interface resources 14 output the data received from the sourcing entity onto the data transport network. Similarly, for example, when the data transport network 12 transports data that is to be logged by a logging entity within the data processing resources 11, the interface resources 14 can access the data transport network 12 transparently with respect to the logging entity. In this transparent access, the interface resources 14 receive the data from the data transport network 12. The interface resources 14 can then provide the received data to the logging entity.

In various embodiments, any of the aforementioned sourcing entities, also referred to herein as data sources, and any of the aforementioned logging entities, also referred to herein as data loggers, can be implemented using any desired type of data processing entity. Examples of such data processing entities include a single-chip data processing apparatus, a multi-chip data processing apparatus, or an application running on either a single-chip or multi-chip data processing apparatus.

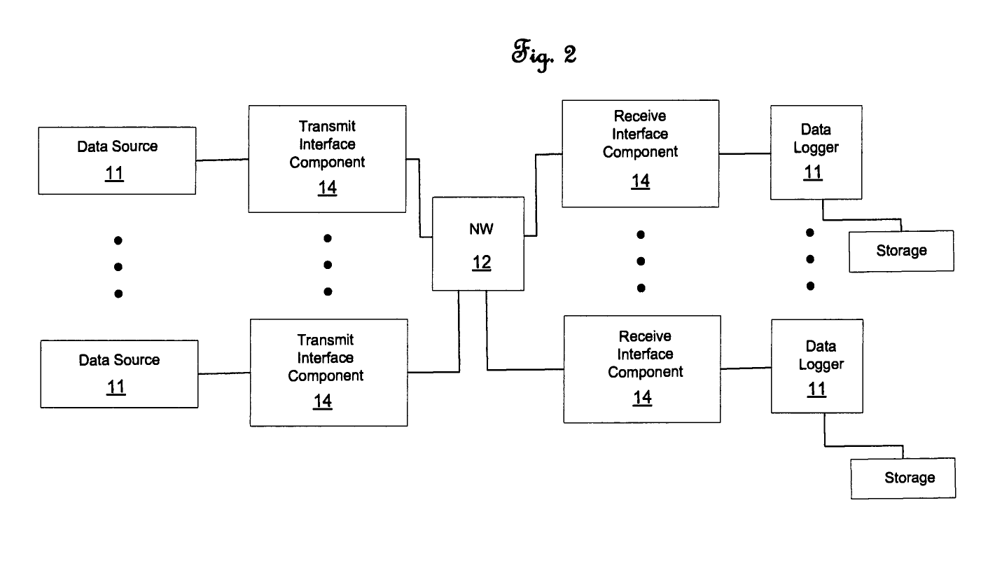

In some exemplary embodiments, the interface resources 14 are defined by a plurality of interface entities (also referred to herein as interface components) that are distributed in the data processing network in correspondence with the distribution of the aforementioned data sources and data loggers. FIG. 2 diagrammatically illustrates a data processing network according to such embodiments. As shown in FIG. 2, each of a plurality of data sources has associated therewith a respectively corresponding one of a plurality of transmit interface components. A transmit interface component (also referred to herein as TIC) accesses the data transport network (also referred to herein as NW) 12 transparently with respect to its associated data source, in order to output data to the data transport network on behalf of the data source. A data source and its associated transmit interface component are also collectively referred to herein as a sourcing end. As also shown in FIG. 2, each of a plurality of data loggers has associated therewith a respectively corresponding one of a plurality of receive interface components. A receive interface component (also referred to herein as RIC) accesses the data transport network 12 transparently with respect to its associated data logger, in order to receive data from the data transport network on behalf of the data logger. A data logger and its associated receive interface component are also collectively referred to herein as a logging end.

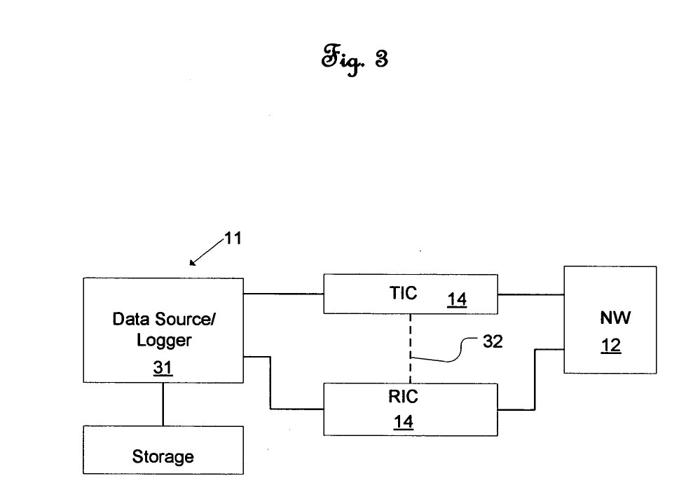

FIG. 2 also illustrates that each data logger has an associated data storage facility (designated as “storage” in FIGS. 2 and 3) coupled thereto. A data logger stores the logged data in its associated data storage facility.

In various embodiments, any of the aforementioned interface components can be implemented using any desired type of data processing entity, for example, a single-chip data processing apparatus, a multi-chip data processing apparatus, or an application running on either a single-chip or multi-chip data processing apparatus. In various embodiments, any given data source and its corresponding transmit interface component can be provided together in a multi-chip data processing apparatus or in a single-chip data processing apparatus. In some embodiments, any given data source and its corresponding transmit interface can be provided together in a user workstation, for example, a desktop computer such as a PC. In various embodiments, any given data logger and its corresponding receive interface component can be provided together in a multi-chip data processing apparatus or in a single-chip data processing apparatus. In some embodiments, any given data logger and its corresponding receive interface can be provided together in a user workstation, for example, a desktop computer such as a PC. In various embodiments, a data logger's associated data storage facility can be provided together with the data logger in a user workstation, or physically separately from the data logger.

In some embodiments, a single data processing entity (such as described above) functions as both a data source and a data logger. FIG. 3 diagrammatically illustrates pertinent portions of a data processing network according to such embodiments. As shown in FIG. 3, a dual-function data processing entity 31 includes both data source functionality and data logger functionality, and thereby implements both a data source and a data logger. The data source of dual-function data processing entity 31 produces and/or collects data that is to be logged by a data logger in another data processing entity (not explicitly shown in FIG. 3) that is connected to the data transport network 12. The data logger of dual-function data processing entity 31 logs data that is produced and/or collected by a data source in another data processing entity (not explicitly shown in FIG. 3) that is connected to the data transport network 12. The dual-function data processing entity 31, also referred to herein as a data source/logger, has associated therewith both a transmit interface component and a receive interface component. The transmit interface component accesses the data transport network 12 transparently with respect to the data logger of the entity 31, in order to output data to the data transport network on behalf of the data source. The receive interface component accesses the data transport network 12 transparently with respect to the data logger of the entity 31, in order to receive data from the data transport network on behalf of the data logger. A data storage facility is coupled to the entity 31 to store data that is logged by the data logger. Some embodiments include a local data path (whose use is described in more detail hereinafter) between the transmit interface and the receive interface, as shown by broken line 32 in FIG. 3.

In various embodiments, any given data source/logger and its corresponding transmit and receive interface components can be provided together in a multi-chip data processing apparatus or in a single-chip data processing apparatus. In some embodiments, any given data source/logger and its corresponding transmit and receive interface components can be provided together in a user workstation, for example, a desktop computer such as a PC.

In some embodiments, a local copy of the data that is being logged is retained locally at the sourcing end until it can be determined, by a suitable form of acknowledgement, that all intended logging ends have received the data. When it is determined that particular locally retained data has been received by all intended logging ends, then the sourcing end discards that particular data. In some embodiments, if it cannot be determined that all intended logging ends have received particular data that has been transmitted for logging, then a local transfer path (see also 32 in FIG. 3) is used to transfer the corresponding locally retained data to a local data logger for logging. In some embodiments, if the amount of locally retained data reaches a threshold amount, then a local transfer path is used to transfer all of the locally retained data to a local data logger. In some embodiments, if the amount of locally retained data reaches a threshold amount, this condition is assumed to indicate that the sourcing end is not connected to the data transport network. Under such a condition, a suitable connection to the data transport network is effected, and the locally retained data is transmitted to the intended logging ends. In some embodiments, a logging end can communicate to a sourcing end an indication that the available storage capacity of the data storage facility at the logging end has reached a low-limit threshold. In response to such an indication, the sourcing end transfers future data intended for that logging end to a local data logger via a local transfer path.

In some embodiments, the interface resources 14 are based on a conventional publish-subscribe messaging model. According to conventional practice, publish-subscribe messaging is implemented as a layer of software (commonly referred to as middleware) that sits on top of the networking stack of the host data processing facility. This publish-subscribe layer provides an API (Application Program Interface—typically standards-based) that presents the publish-subscribe model of communication. The publish-subscribe layer handles the network I/O and management needed for reliable and transparent transfers, without requiring intervention by the user's application. For example, the publish-subscribe layer transparently handles message addressing, data marshalling and unmarshalling, flow control, retries, etc. The publish-subscribe layer thus provides a pluggable transport framework that can be used with a variety of conventional data transport mechanisms.

The Object Management Group, Inc. (OMG) document, “Data Distribution Service for Real-Time Systems Specification,” Version 1.1, formal/05-12-04, December 2005 (hereinafter “OMG Specification”), is incorporated herein by reference. The OMG Specification describes in detail conventional examples of publish-subscribe messaging. One publish-subscribe messaging model described therein is referred to as the Data-Centric Publish-Subscribe (DCPS) model. As used herein, terms such as “publish-subscribe,” “publish-subscribe model,” “publish-subscribe messaging” and the like, should be understood to encompass the aforementioned DCPS model and other conventionally known publish-subscribe models, and generally to encompass arrangements and techniques that exhibit structural and/or operational equivalence relative to conventional publish-subscribe models.

The DCPS model uses the concept of a “global data space” that is accessible to all interested applications. Applications that want to contribute information to the global data space declare themselves to be publishing applications, and applications that want to obtain information from the global data space declare themselves to be subscribing applications. Each time a publishing application posts new data in the global data space, the publish-subscribe facilities propagate the new data to all interested (i.e., subscribing) applications. The OMG Specification describes data modeling that can be used to define the aforementioned global data space. One data model described in the OMG Specification is a set of data-structures, each of which is identified by a “Topic” and a “Type.” The “Topic” is an identifier that uniquely identifies some data items within the global data space. The “Type” is data-structural information that tells the publish-subscribe layer how to manipulate the data. Fundamentally, the publish-subscribe layer provides the functionality required for publishing applications to transmit values of data objects, and for subscribing applications to receive values of data objects. A publishing application identifies data objects and provides values for those objects. A subscribing application identifies data objects of interest, and obtains the values of those data objects. Any application can be a publishing application, a subscribing application, or both.

Still referencing the OMG Specification, the publish-subscribe layer described therein implements constructs referred to as Publisher and Data Writer. A Publisher is an object responsible for data distribution, and can distribute data having various different Types associated therewith. A Data Writer is an object that the publishing application uses to communicate to the Publisher the existence and values of data objects. Data Writer objects are dedicated to respectively corresponding Types. When a publishing application communicates data object values to a Publisher via the appropriate Data Writer, it is then the Publisher's responsibility to perform the data distribution. The association of a Data Writer to a Publisher is referred to as a Publication. The Publication expresses the intent of the publishing application to publish the data described by the Data Writer in the context provided by the Publisher.

The publish-subscribe layer described in the OMG Specification also implements constructs referred to as Subscriber and Data Reader. A Subscriber is an object responsible for receiving published data and making it available to a subscribing application. A Subscriber can receive and dispatch data having various different Types. A Data Reader is an object that a subscribing application uses to obtain the data from the Subscriber. Data Reader objects are dedicated to respectively corresponding Types. The association of a Data Reader to a Subscriber is referred to as a Subscription. The Subscription expresses the intent of the subscribing application to subscribe to the data described by the Data Reader in the context provided by the Subscriber.

When a publishing application wishes to transmit data, it creates a Publisher and a Data Writer to define the needed Publication. Similarly, when a subscribing application wishes to receive data, it creates a Subscriber and a Data Reader to define the needed Subscription. Publishers, Data Writers, Subscribers and Data Readers that have already been created can be re-used, to conserve resources.

Still referencing the OMG Specification, a Topic object operates conceptually between a Publisher and a Subscriber. A Topic object associates a Topic together with a Type, and one of its purposes is to permit a Subscription to refer unambiguously to a Publication.

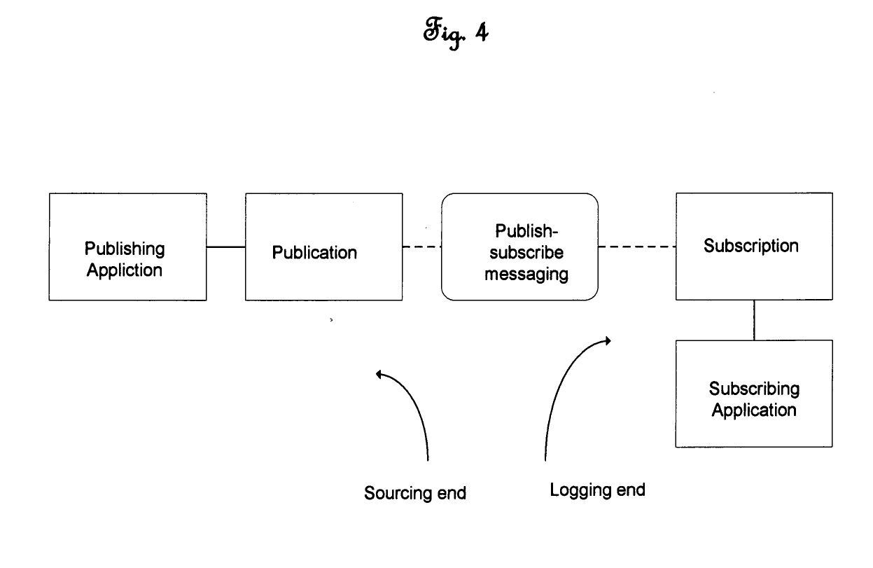

FIG. 4 diagrammatically illustrates pertinent portions of a data processing network according to exemplary embodiments of the invention that use the publish-subscribe model. As shown in FIG. 4, a Publication and Subscription cooperate (in conjunction with the data transport network 12, not shown) to perform publish-subscribe messaging between a publishing application and a subscribing application Considering FIG. 4 together with FIGS. 2 and 3, it can be seen that the publishing application and Publisher constitute a sourcing end as described above, and the subscribing application and Subscription constitute a logging end as described above.

In some embodiments, an identifier specifically associated with a given sourcing end can be used to define the Topic. In some embodiments, the Topic can be generated dynamically at run time at the sourcing and logging ends. In some embodiments, run-time Topic generation is accomplished using executable configuration data from a configuration file. In various embodiments, run-time Topic generation is accomplished by any suitable run-time data input technique, for example, command line input. The dynamic, run-time definition of a Topic that specifies a particular sourcing end effectively creates a message filter. Through the use of such message filters, any given logging end can produce logs associated with multiple sourcing ends.

Some embodiments employ a Type that contains a static component having data elements that have a fixed definition (e.g., for data that do not differ among different data sources), and a dynamic component having data elements that are dynamically variable as defined by users. The structure of the dynamic component can thus be varied by users as may be required to comport with the nature of the data that is to be logged. In some embodiments, the dynamic component has a data construct that is defined by a text string that follows a “comma-separated/semicolon-separated” string data format such as follows:

<type of data>, <data value>; <type of data>, <data value>; . . . .

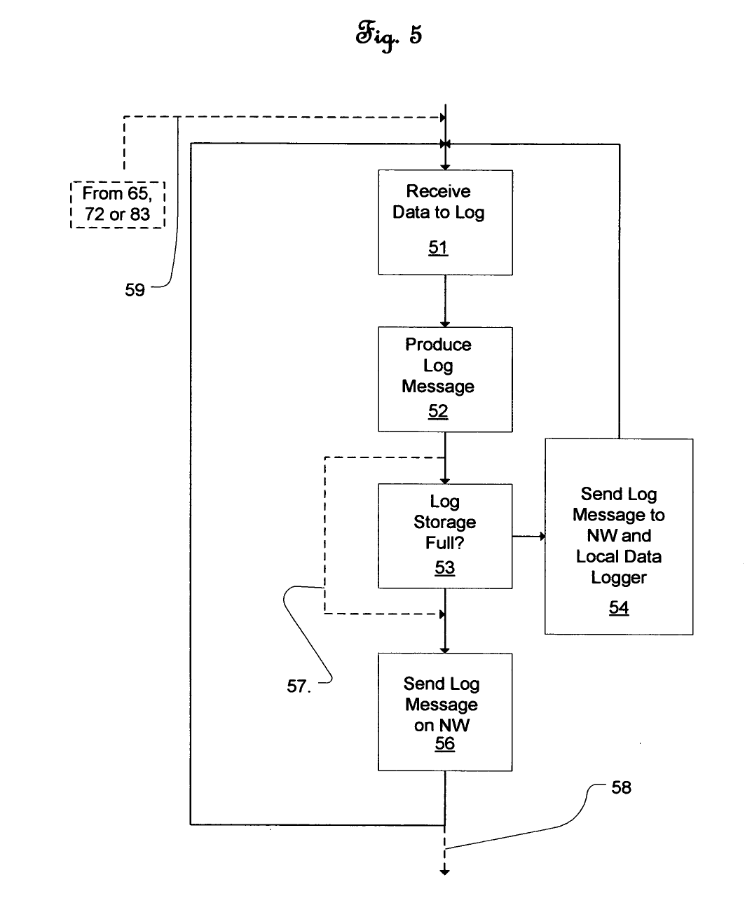

FIG. 5 illustrates operations that can be performed according to exemplary embodiments of the invention. In various embodiments, operations shown in FIG. 5 can be performed by sourcing ends described above with respect to FIGS. 1-4. Referencing FIG. 5 in detail, when data to be logged is available at 51, a suitable message (also referred to herein as a log message) containing the data is created at 52.

In some embodiments, operations proceed directly from 52 to 56 (as indicated by broken line 57), where the log message is sent on the data transport network. Thereafter, operations return to 51.

In some embodiments, after producing the log message at 52, it is determined at 53 whether any logging end has reported that its log storage (data storage facility) is full, e.g., has reached a low-limit threshold for available capacity. If not, then the log message is sent on the data transport network at 56, after which operations return to 51.

If at 53 any logging end has reported that its log storage is full, then at 54 the log message is sent to a local data logger (e.g., via the local data path 32 of FIG. 3), and is also sent on the data transport network. Thereafter, operations return to 51.

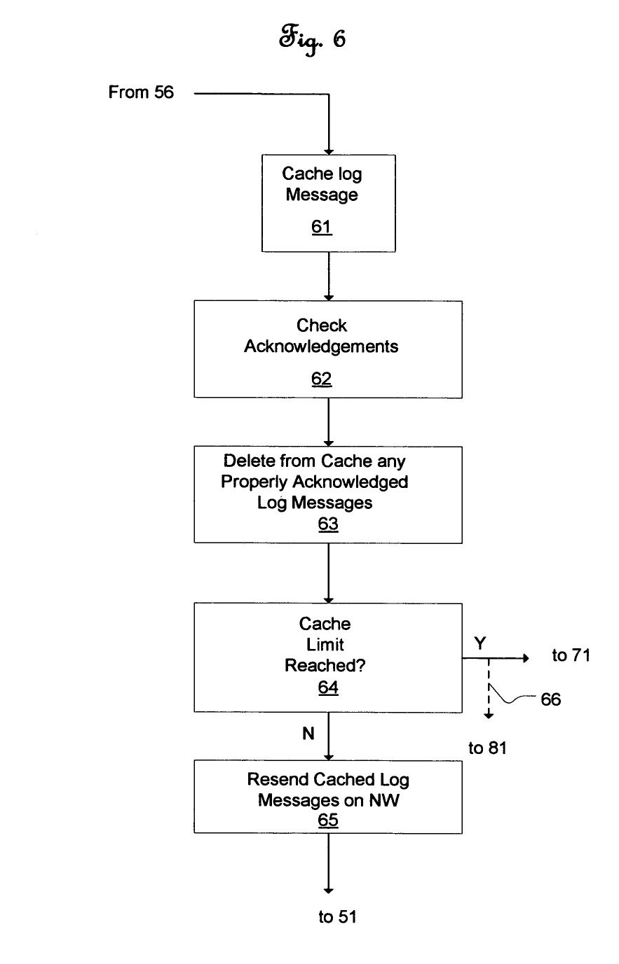

FIGS. 6-8 illustrate operations that can be performed according to exemplary embodiments of the invention. In various embodiments, operations shown in FIGS. 6-8 can be performed by sourcing ends described above with respect to FIGS. 1-4. In some embodiments, operations proceed from 56 in FIG. 5 to 61 in FIG. 6 (see also broken line 58 in FIG. 5). The log message that has been sent on the data transport network (see also 56 in FIG. 5) is cached at 61 to retain a local copy thereof. The status of acknowledgements from logging ends is checked at 62. At 63, any properly acknowledged log message(s) can be deleted from the cache.

In some embodiments, a log message is considered properly acknowledged only if acknowledgement has been received from all intended logging ends. In some embodiments, the sourcing end is informed of the number of intended logging ends (and thus the number of expected acknowledgements) for a given log message by means of configuration data provided in a configuration file.

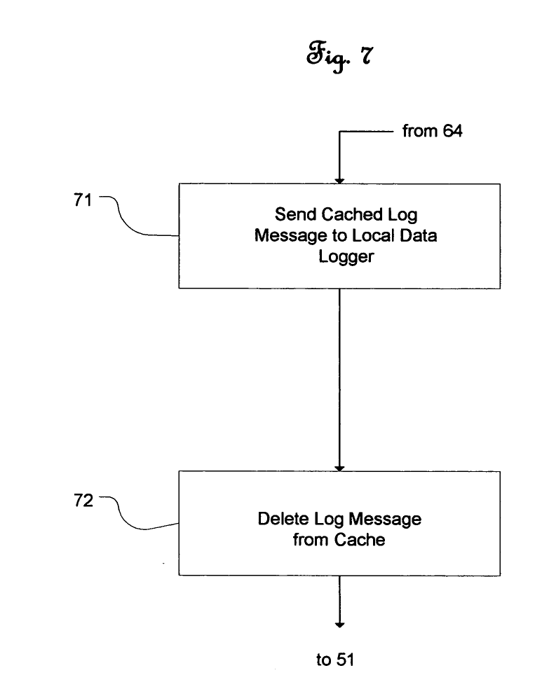

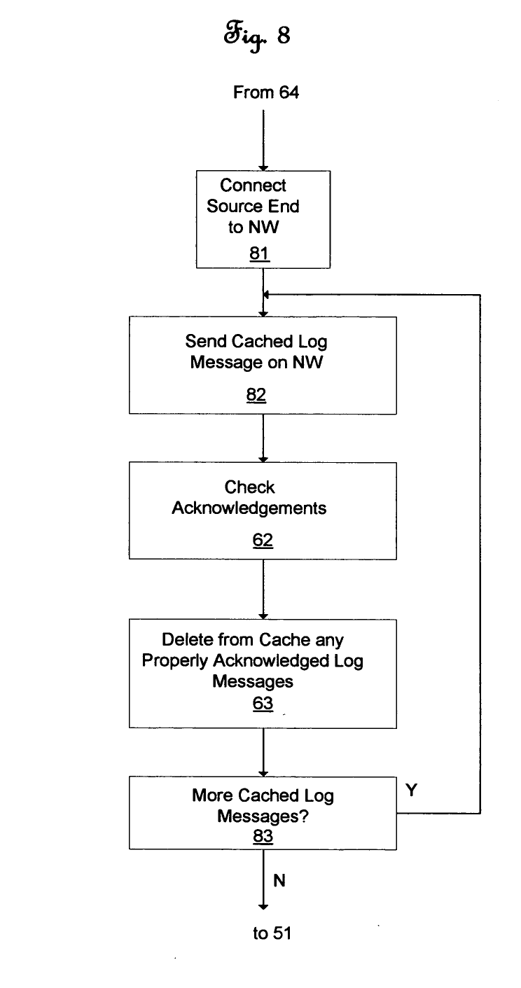

After any appropriate cache deletions are performed at 63 in FIG. 6, it is determined at 64 whether a cache limit has been reached, for example, whether the number of cached messages exceeds a threshold. If the cache limit has not been reached at 64, then the cached messages (which have not been properly acknowledged) are re-sent at 65, after which operations return to 51 in FIG. 5 (see also broken line 59 in FIG. 5). In some embodiments, if the cache limit is reached at 64, operations proceed to 71 in FIG. 7, where a local data logger is used. In other embodiments, if the cache limit is reached at 64, operations proceed to 81 in FIG. 8 (as shown by broken line 66 in FIG. 6), to connect the sourcing end to the data transport network.

As shown at 71 in FIG. 7, after determining that the cache limit has been reached (see also 64 in FIG. 6), the cached log messages are sent to a local data logger (e.g., via the local data path 32 of FIG. 3). The cached log messages are deleted at 72, after which operations return to 51 in FIG. 5 (see also broken line 59 in FIG. 5).

As shown at 81 in FIG. 8, after determining that the cache limit has been reached (see also 64 in FIG. 6), the source end is placed into connection with the data transport network. After sending a cached log message at 82, the acknowledgement check and cache deletion operations 62 and 63 are performed as in FIG. 6. As shown at 83, the process of sending cached messages, checking acknowledgements and deleting cached messages continues until all log messages have been deleted from cache, after which operations return to 51 in FIG. 5 (see also broken line 59 in FIG. 5).

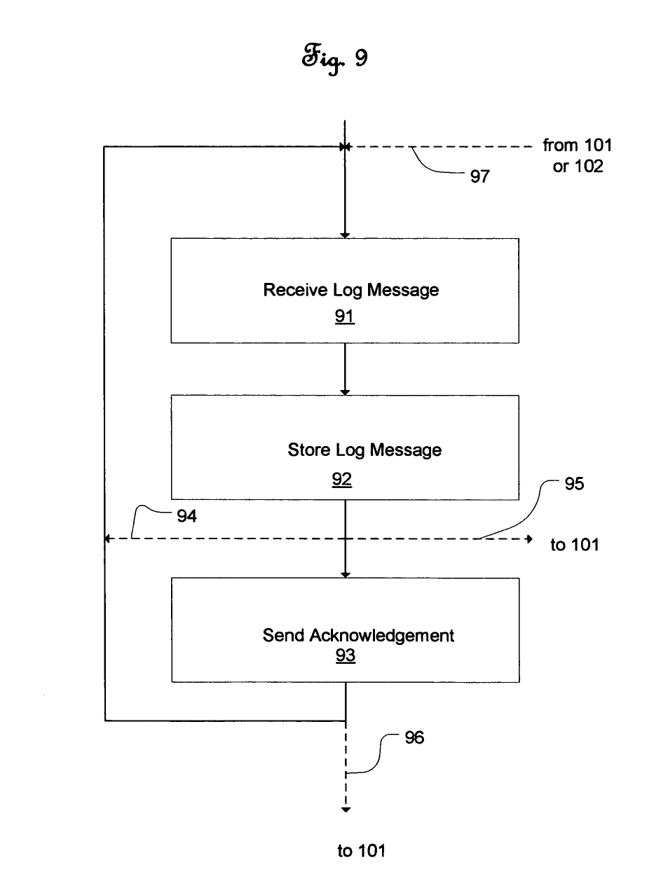

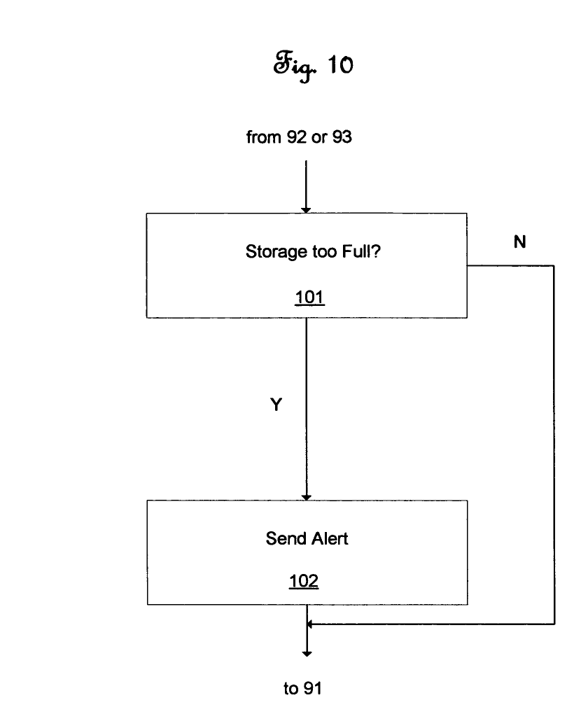

FIGS. 9 and 10 illustrate operations that can be performed according to exemplary embodiments of the invention. In various embodiments, operations shown in FIGS. 9 and 10 can be performed by logging ends described above with respect to FIGS. 1-4. After receiving a log message at 91 in FIG. 9, the log message is at 92 stored in a storage facility. In some embodiments, the storing at 92 includes time-stamping the log message, entering the time-stamped log message into a time-ordered log, and storing the time-ordered log. After the storage operation at 92, an acknowledgment is sent at 93 to inform the sourcing end that the logging end has received the log message, after which operations return to 91 to await the next log message.

In some embodiments, operations return directly to 91 after the storage operation at 92. This is indicated in FIG. 9 by broken line 94.

As shown by broken line 95 in FIG. 9, in some embodiments, operations proceed from 92 in FIG. 9 to 101 in FIG. 10. Thus, after the storage operation at 92 in FIG. 9, it is determined at 101 in FIG. 10 whether the storage facility at the logging end is too full. If not, operations return to 91 in FIG. 9 (see also broken line 97 in FIG. 9). If the storage facility is too full at 101, then at 102 an alert indicative of this condition is sent to the sourcing end, after which operations return to 91 in FIG. 9 (see also broken line 97 in FIG. 9).

As shown by broken line 96 in FIG. 9, in some embodiments, operations proceed from 93 in FIG. 9 (sending acknowledgement) to 101 in FIG. 10, so the storage facility check and alert operations shown at 101 and 102 can be performed as described above.

In various embodiments, the aforementioned acknowledgements are implemented by standard acknowledgement messages used by conventional publish-subscribe middleware to acknowledge receipt of published messages by subscribing applications. These standard acknowledgement messages carry message identifiers that the publish-subscribe middleware conventionally assigns to (and includes in) each message that is published. Log messages that are retained locally (e.g., cached) therefore include the message identifiers that are needed to match them to the received acknowledgement messages.

In some embodiments, the Publisher generates a unique sequence number for each log message. This sequence number is transmitted to the logging end(s) together with the associated log message. When a logging end receives the log message and its associated sequence number, the logging end sends the sequence number back to the Publisher at the source end. The sequence number is thus used by the logging end(s) to verify that the associated log message has been received. For a given log message, until the Publisher receives the associated sequence number from all logging ends to which the associated log message has been sent, the Publisher retains the log message in local cache, and continues to transmit that log message (in addition to any new log messages requiring transmission). Some embodiments generate a local alert at the source end if a sequence number is not received by the Publisher within a predetermined time window. In some embodiments, the Publisher generates a local alert when the number of log messages stored in local cache reaches a predetermined threshold. These local alerts serve as error detection mechanisms, indicating that there is a problem in the message logging process.

In some embodiments, when the logging end recognizes that its storage has reached a preset capacity, it generates a local alert. This alert is only used locally at the logging end, and is not transmitted back to the Publisher at the source end. In such embodiments, the Publisher is not involved in handling problems associated with available storage capacity at the logging end. In some embodiments, the local alert is used by the logging end to initiate archiving of the stored log messages onto suitable non-volatile memory (for example a DVD±R), after which the storage facility at the logging end is again available to store received log messages.

Although exemplary embodiments of the invention have been described above in detail, this does not limit the scope of the invention, which can be practiced in a variety of embodiments.

What is claimed is:

1. A data processing apparatus, comprising:
a data source configured to provide data for logging by a data logger; and
an interface coupled to said data source, said interface adapted to be coupled to a data transport network that supports delivery of said data to said data logger, said interface configured to receive said data from said data source, and to provide said data to the data transport network transparently with respect to said data source.

2. The apparatus of claim 1, wherein said interface is configured to implement a publish component of publish/subscribe messaging.

3. The apparatus of claim 1, wherein said interface processes a message that includes said data, said message having a format that supports a variable data construct for said data.

4. The apparatus of claim 1, wherein said interface uses an identifier for said data, and said identifier associates said data with said data source.

5. The apparatus of claim 4, wherein said interface processes a message that includes said data, said message having a format that supports a variable data construct for said data.

6. The apparatus of claim 1, wherein said interface and said data source are provided together in a user workstation.

7. A data processing apparatus, comprising:
a data logger configured to log data that has been provided by a data source; and
an interface coupled to said data logger, said interface adapted to be coupled to a data transport network that supports delivery of said data from the data source, said interface configured to receive said data from the data transport network transparently with respect to said data logger, and to provide said data to said data logger.

8. The apparatus of claim 7, wherein said interface is configured to implement a subscribe component of publish/subscribe messaging.

9. The apparatus of claim 7, wherein said interface processes a message that includes said data, said message having a format that supports a variable data construct for said data.

10. The apparatus of claim 7, wherein said interface uses an identifier for said data, and said identifier associates said data with the data source.

11. The apparatus of claim 10, wherein said interface processes a message that includes said data, said message having a format that supports a variable data construct for said data.

12. The apparatus of claim 7, wherein said interface and said data logger are provided together in a user workstation.

13. A data processing network apparatus, comprising:
a data source configured to provide data to be logged;
a data logger configured to log said data;
a data transport network;
an interface coupled to said data transport network, said data source and said data logger;
said interface configured to receive said data from said data source, and to provide said data to said data transport network transparently with respect to said data source; and
said interface further configured to receive said data from said data transport network transparently with respect to said data logger, and to provide said data to said data logger.

14. The apparatus of claim 13, wherein said interface is configured to implement publish/subscribe messaging.

15. The apparatus of claim 13, wherein said interface processes a message that includes said data, said message having a format that supports a variable data construct for said data.

16. The apparatus of claim 13, wherein said interface uses an identifier for said data, and said identifier associates said data with said data source.

17. The apparatus of claim 16, wherein said interface processes a message that includes said data, said message having a format that supports a variable data construct for said data.

18. A data processing method, comprising:
receiving, from a data source, data that has been provided by the data source and is to be logged by a data logger;
providing the data received from the data source to a data transport network transparently with respect to the data source;
transporting the data in the data transport network;
receiving the data from the data transport network transparently with respect to the data logger; and
providing the data received from the data transport network to the data logger.

19. The method of claim 18, wherein said first-mentioned providing includes performing a publish operation associated with publish/subscribe messaging, and said last-mentioned receiving includes performing a subscribe operation associated with publish/subscribe messaging.

20. The method of claim 18, wherein said first-mentioned providing and said last-mentioned receiving each include processing a message that includes said data, said message having a format that supports a variable data construct for said data.

21. The method of claim 18, wherein said first-mentioned providing and said last-mentioned receiving each include using an identifier for said data, and wherein said identifier associates said data with the data source.

22. The method of claim 21, wherein said first-mentioned providing and said last-mentioned receiving each include processing a message that includes said data, said message having a format that supports a variable data construct for said data.

23. The method of claim 18, including retaining for the data source a local copy of said data.

24. The method of claim 23, including sending the local copy of said data to a local data logger independently of the data transport network, in response to a condition wherein a quantity of local copies of data that have been retained for the data source reaches a threshold.

25. The method of claim 24, including discarding the local copy of said data in response to a condition wherein all data loggers that are intended to receive said data have acknowledged receipt of said data.

26. The method of claim 23, including discarding the local copy of said data in response to a condition wherein all data loggers that are intended to receive said data have acknowledged receipt of said data.

27. The method of claim 18, including also sending said data to a local data logger independently of the network, in response to an indication that a data storage capacity of the first-mentioned data logger has reached a threshold.
